(19) United States
(12) Patent Application Publication
(10) Pub. No.: US 2017/0094120 A1
(43) Pub. Date: Mar. 30, 2017

(54) DEVICE INFORMATION REGISTRATION SYSTEM, CONTROL METHOD FOR MANAGEMENT APPARATUS, AND STORAGE MEDIUM

(71) Applicant: CANON KABUSHIKI KAISHA, Tokyo (JP)

(72) Inventor: Hiroaki Towata, Great Neck, NY (US)

(21) Appl. No.: 15/270,840

(22) Filed: Sep. 20, 2016

(30) Foreign Application Priority Data
Sep. 25, 2015 (JP) 2015-187998

(51) Int. Cl. H04N 1/44; H04L 29/06; H04N 1/00; H04L 29/12

(52) U.S. Cl. CPC H04N 1/4426; H04L 61/2007; H04L 65/1073; H04N 1/00251; H04N 1/00344; H04N 1/00336; H04L 67/10

(57) ABSTRACT

There is provided a device information registration system in which an IP address of a login device is detected from a first management apparatus, and the detected IP address and position information of the device in an image captured by a network camera are associated and registered in a device information table.

### BACKGROUND

Field

Aspects of the present invention generally relate to a device information registration system, a management apparatus, a control method for a management apparatus, and a storage medium.

Description of the Related Art

Recently, in image forming apparatuses including multiple functions, such as printing, copying, and scanning, a technique of displaying an operation screen designed for each user and limiting the use of the functions for each user have been known.

Such image forming apparatuses involve user authentication processing. General examples of the user authentication processing include a password authentication method and a card based authentication method. In a configuration where the password authentication method is employed, a user inputs the user's user ID and password through an operation panel of the image forming apparatus. In a configuration employing the card based authentication method, the user logs in by holding the user's card over a device, which is attached to the image forming apparatus, for card authentication. The password authentication method requires the user to perform a cumbersome operation, while the card based authentication method includes a risk that a user with another user's card can login as the other user.

A technique for addressing this is discussed in Japanese Patent Application Laid-Open No. 2009-147452. This technique features the use of face recognition for user authentication for the image forming apparatus.

To implement the technique in Japanese Patent Application Laid-Open No. 2009-147452, an image capturing apparatus is needed. Adding such an apparatus to an image forming apparatus can result in higher manufacturing costs associated with the image forming apparatus. One technique of implementing face recognition for is to take advantage of network cameras installed in an office environment where the image forming apparatus is located.

Implementation of face recognition for user recognition requires registration of an Internet Protocol (IP) address of each image forming apparatus using this authentication method. However, such a registration operation is cumbersome for an administrator, and likely to result in faulty registration.

### SUMMARY OF THE INVENTION

Aspects of the present invention are generally directed to a technique that automatically registers an IP address of an image forming apparatus in an image captured by a network camera.

According to an aspect of the present invention, a device information registration system includes a network camera, a first management apparatus configured to execute authentication processing for a user logging into a device, and a second management apparatus configured to manage a device or a user in an image captured by the network camera, wherein the first management apparatus includes an authentication unit configured to execute the authentication processing for the user logging into the device, and wherein the second management apparatus includes a first detection unit configured to detect a user approaching the device based on the image captured by the network camera, a second detection unit configured to monitor, in a case where the user is detected, the authentication processing executed by the first management apparatus, to detect whether the user has logged into the device, a third detection unit configured to detect an IP address of the device logged in by the user from the first management apparatus, and a registration unit configured to associate and register the detected IP address and position information of the device in the image captured by the network camera into a device information table.

Further features of the aspects of the present invention will become apparent from the following description of exemplary embodiments with reference to the attached drawings.

### BRIEF DESCRIPTION OF THE DRAWINGS

FIG. 1 is a diagram illustrating an example of a configuration of a device information registration system.

FIG. 2 is a block diagram illustrating a hardware configuration of the device information registration system.

FIG. 3 is a block diagram illustrating a software configuration of the device information registration system.

FIG. 4 is a sequence diagram illustrating processing executed in the device information registration system.

FIG. 5 is a diagram illustrating a configuration of a device information registration system.

FIG. 6 is a block diagram illustrating a software configuration of the device information registration system.

FIG. 7 is a sequence diagram illustrating processing executed in the device information registration system.

### DESCRIPTION OF THE EMBODIMENTS

Exemplary embodiments of the present invention will be described with reference to the drawings.

### <System Configuration>

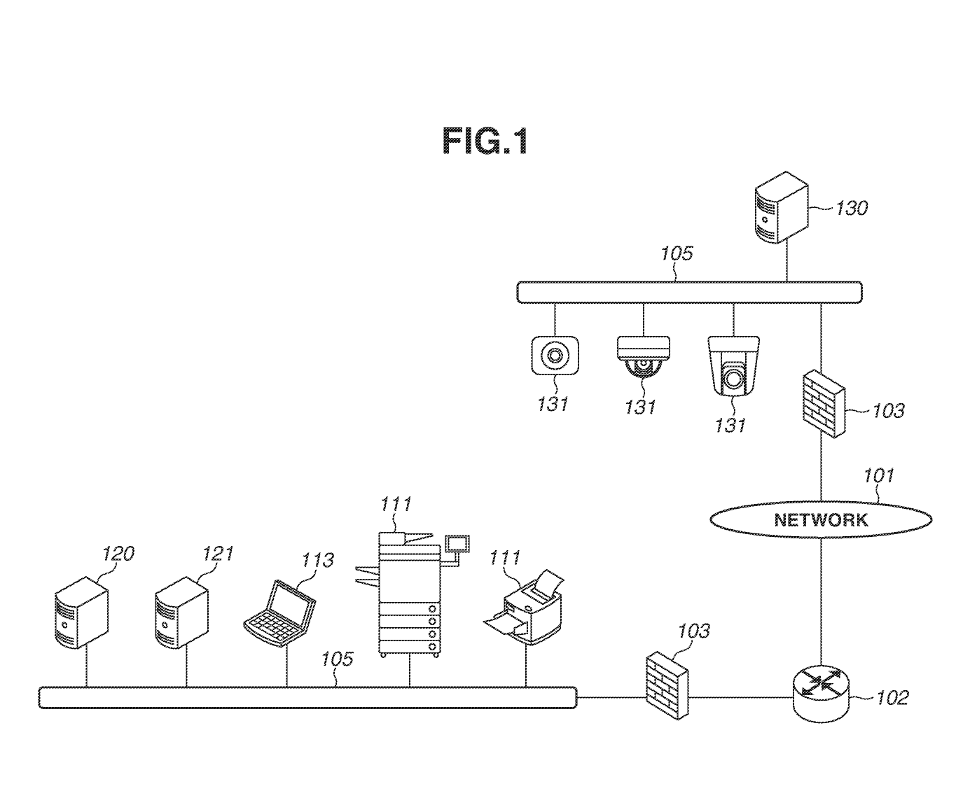

FIG. 1 is a diagram illustrating an example of a configuration of a device information registration system according to a first exemplary embodiment of the present invention. The system includes a plurality of servers each functioning as a management apparatus, information processing apparatuses, network cameras, and image forming apparatuses. In some cases, a plurality of the network cameras is arranged close to each other so that images of a single apparatus can be captured with different angles of views of the respective network cameras.

The system illustrated in FIG. 1 includes a network 101, such as the Internet, an intranet, a networking device 102, such as a router or a switch that connects networks, a firewall 103 that controls communication permission between networks, and a local area network (LAN) 105 that is an end network to which devices, such as a computer, are connected. The LAN 105 is not limited to a wired communication network, and can be a wireless communication network such as a wireless LAN or a mobile phone communication network.

The system further includes image forming apparatuses 111, a client computer 113, an authentication server 120, a device management server 121, network cameras 131, and a face recognition server 130. The image forming apparatuses 111 include a single-function printer (SFP), a multi-function printer (MFP) including multiple functions such as copying, scanning, and printing. The client computer 113 can include a personal computer, a tablet computer, a smartphone, etc. The network camera 131 can include fixed box types, pan/tilt types, wide-angle types determined by different lenses and operation mechanisms, etc.

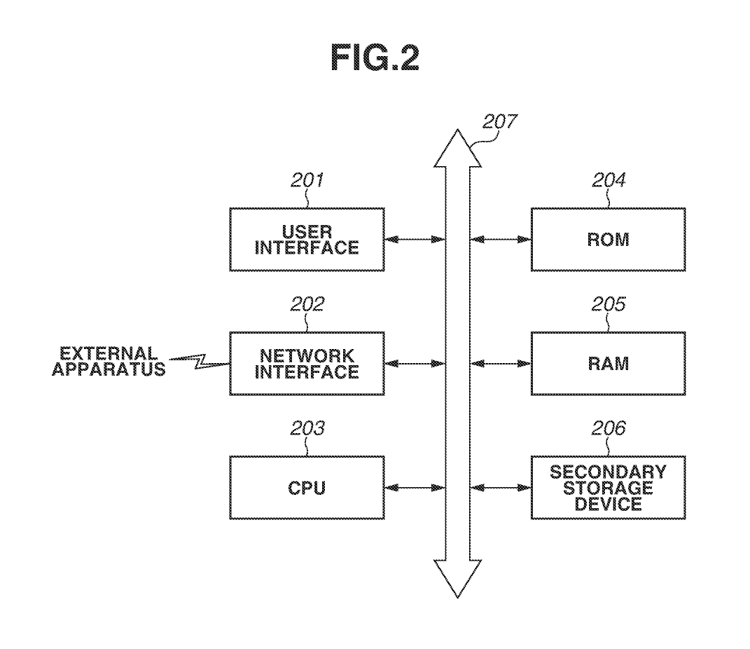

FIG. 2 is a block diagram illustrating a hardware configuration of each of the client computer 113, the authentication server 120, the device management server 121, and the face recognition server 130 illustrated in FIG. 1.

The configuration illustrated in FIG. 2 includes a user interface 201, a network interface 202, a central processing unit (CPU) 203, a read only memory (ROM) 204, a random access memory (RAM) 205, a secondary storage device 206, and an input/output interface 207. The user interface 201 is in charge of information input/output via a display, a keyboard, a mouse, a touch panel, etc. A computer without such hardware can be connected and operated by a remote computer via a remote desktop, a remote shell, etc. The network interface 202 is connected to a network, such as a LAN, and is used for communicating with other computers and networking devices.

The ROM 204 stores installed programs and data. The RAM 205 serves as a temporary memory area. The CPU 203 executes a program read from the ROM204, the RAM205, the secondary storage device 206, such as a hard disk drive (HDD), etc. These devices are connected with each other via the input/output interface 207.

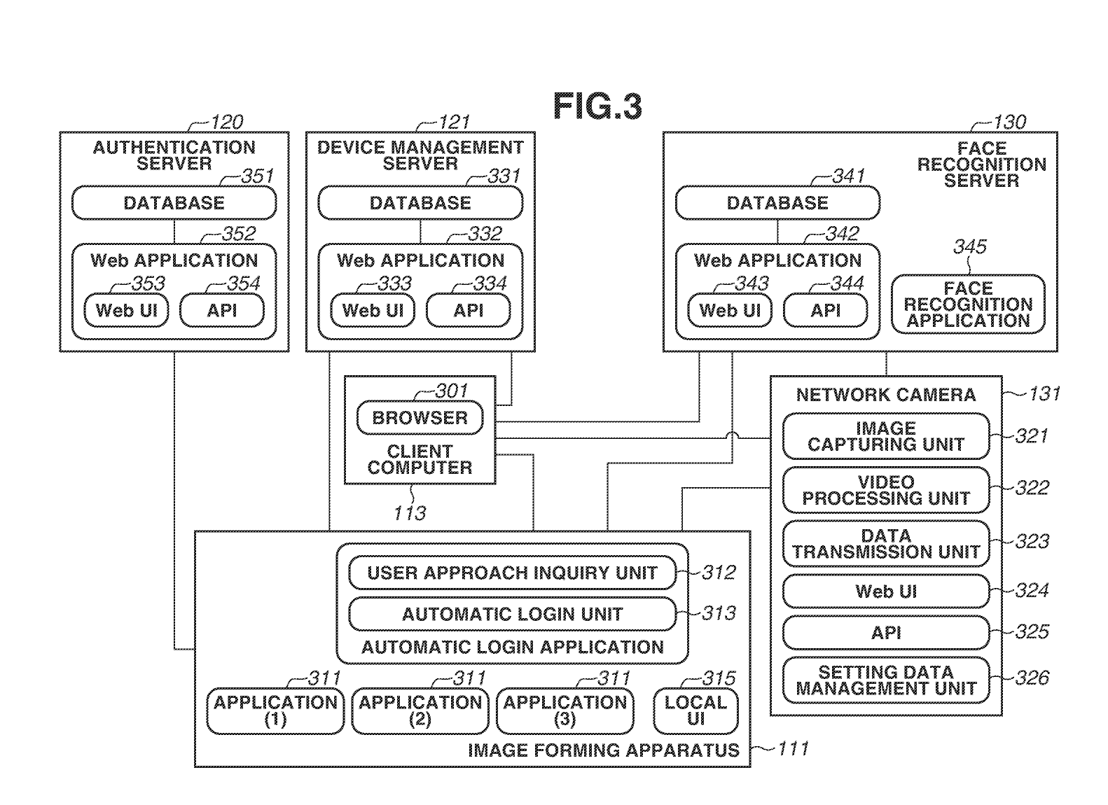

FIG. 3 is a block diagram illustrating a software configuration of the device information registration system according to the present exemplary embodiment. Modules for information processing functions of the image forming apparatus 111, the client computer 113, the authentication server 120, the device management server 121, the network camera 131, and the face recognition server 130 are described below.

In FIG. 3, the device management server 121 includes a database 331 and a Web application 332. The database 331 stores data required for various functions of the device management server 121. The Web application 332 provides a Web user interface (hereinafter, referred to as a Web UI) 333 and an application programming interface (hereinafter, referred to as an API) 334. The Web application 332 processes a request from other devices received through a network. Thus, the Web application 332 accesses data in the database 331 to execute various functions, and returns a response as appropriate.

The face recognition server 130 includes a database 341, a Web application 342, and a face recognition application 345. The database 341 stores data required for various functions of the face recognition server 130. The Web application 342 provides a Web UI 343 and an API 344. The Web application 342 processes a request from other devices received through a network. Thus, the Web application 342 accesses data in the database 341 to execute various functions, and returns a response as appropriate.

The client computer 113 includes a browser 301 that displays various UI screens on the client computer 113.

The authentication server 120 includes a database 351 and a Web application 352. The database 351 stores data required for various functions of the authentication server 120. The Web application 352 provides a Web UI 353 and an API 354. The Web application 352 processes a request from other devices received through a network. Thus, the Web application 352 accesses data in the database 351 to execute various functions, and returns a response as appropriate.

The network camera 131 includes an image capturing unit 321, a video processing unit 322, a data transmission unit 323, and a Web UI 324. The image capturing unit 321 acquires an image by controlling a lens, an image sensor, and the like of the camera. The video processing unit 322 processes an original image acquired by the image capturing unit 321 to obtain video. The video processing unit 322 also executes additional processing, such as image recognition, to acquire additional information from an image or a video. The data transmission unit 323 transmits the video data to other devices on the network. The Web UI 324 provides a viewer screen and a management screen of the network camera 131.

A user can perform operations of adjusting an orientation, zooming, focusing, and the like of the camera while checking the video obtained by the camera on the viewer screen. The user can perform various operations on the management screen. Such operations include preset registration of an imaging position, designation of processing executed by the video processing unit 322, and a destination registration of the video data transmitted from the data transmission unit 323. The network camera 131 further includes an API 325 and a setting data management unit 326. The API 325 operates the camera, and registers setting data, in response to a request from the other devices. The setting data management unit 326 holds setting data for the image capturing unit 321, the video processing unit 322, and the data transmission unit 323.

The image forming apparatus 111 executes an application 311. A plurality of the applications 311 with various functions for various purposes can be installed and executed in the image forming apparatus 111. Examples of the applications 311 include those for executing copying, scanning, and printing.

The image forming apparatus 111 includes a user approach inquiry unit 312 and an automatic login unit 313. The image forming apparatus 111 itself cannot detect an approaching user, and thus transmits an inquiry to the face recognition server 130 to detect the approaching user. The image forming apparatus 111 transmits a login request to the authentication server 120 when the user approaches the image forming apparatus 111, so that the user is automatically logged in.

The image forming apparatus 111 further includes a local UI 315, on the user interface 201 of the image forming apparatus 111, that provides a login screen for using the image forming apparatus 111. The user can use various functions of the image forming apparatus 111 after inputting the user's ID and password on the login screen. The user can also use an identification (ID) card for using the image forming apparatus 111.

TABLE 1
DEVICE MANAGEMENT TABLE T400

| C401 | C402 | C403 | C404 | C405 | C406 | C407 |
|---|---|---|---|---|---|---|
| DEVICE | IP | MANUFACTURE | MODEL | DEVICE | COLOR | INSTALLED |
| SERIAL ID | ADDRESS | NAME | NAME | TYPE | TYPE | LOCATION |
| NNNN00001 | 192.168.1.101 | CXXXN | C5000 | MFP | COLOR | 1F |
| NNNN00002 | 192.168.1.101 | CXXXN | L3500 | SFP | MONO | 3F |

Table 1 illustrates a device management table T400 used for managing a plurality of the image forming apparatuses 111 that is stored in the database 331. The device management table T400 includes a column C401 storing a device serial ID of each of the image forming apparatuses 111, a column C402 storing an IP address of each of the image forming apparatuses 111, a column C403 storing a manufacture name, a column C404 storing a model name, a column C405 storing a device type, such as MFP and SFP, a column C406 storing a color type indicating whether the image forming apparatus 111 can perform monochrome only printing or color printing, and a column C407 storing information on an installed location of the image forming apparatus 111.

The device serial ID (C401) is a unique ID for identifying each image forming apparatus 111 and is provided to each image forming apparatus 111 at the time of manufacturing. It is recorded in a nonvolatile storage area, such as the ROM 204, to be readable by the image forming apparatus 111. When the device serial ID can be recognized, required information such as a model name of the image forming apparatus 111 can be identified by referring to the device management table T400. The image forming apparatus 111 transmits its information corresponding to the columns C401 to C407 when being registered as a management target by the device management server 121. Thus, the device management server 121 adds a record to the device management table T400.

TABLE 2
NETWORK CAMERA MANAGEMENT TABLE T410

| | C412 | C413 | C414 | C415 | C416 |
|---|---|---|---|---|---|
| C411 | MANUFACTURE | MODEL | CAMERA | CAMERA | INSTALLED |
| IP ADDRESS | NAME | NAME | TYPE | NAME | LOCATION |
| 192.168.2.101 | CXXXN | WV-1 | PAN/TILT | WV-1 | 1F RoomA |
| | | | | (1F | |
| | | | | RoomA) | |
| 192.168.2.102 | CXXXN | WV-9 | WIDE | WV-9 | 3F RoomC |
| | | | ANGLE | (3F | |
| | | | | Room C) | |
| 192.168.2.103 | CXXXN | WV-11 | FIXED | WV-11 | 4F RoomD |
| | | | BOX | (4F | |
| | | | | RoomD) | |

Table 2 illustrates a network camera management table T410 used for managing a plurality of the network cameras 131 that is stored in the database 341. The network camera management table T410 includes a column C411 storing an IP address of each of the network cameras 131, a column C412 storing a manufacturer name, a column C413 storing a model name, a column C414 storing a camera type, such as pan/tilt, wide angle, and fixed box, a column C415 storing a camera name set for each of the network cameras 131, and a column C416 storing information on an installed location of each of the network cameras 131.

TABLE 3
IN-IMAGE DEVICE MANAGEMENT TABLE T420

| | | C423 | C424 |
|---|---|---|---|
| C421 | | COORDINATE | COORDINATE |
| NETWORK | C422 | X IN | Y IN |
| CAMERA IP | DEVICE IP | CAPTURED | CAPTURED |
| ADDRESS | ADDRESS | IMAGE | IMAGE |
| NVS_00001 | 192.168.1.101 | 200 | 400 |
| NVS_00002 | null | 20 | 612 |
| NVS_00002 | null | 810 | 300 |
| NVS_00003 | null | 10 | 36 |

Table 3 is an in-image device management table T420, in the database 341, used for managing the image forming apparatus 111 in the image captured by the network camera 131. The in-image device management table T420 serves as a device information table in which the IP address of a device detected through login processing is associated with the information on the position of the device. The image forming apparatus 111 in the captured image is recognized by object recognition and is automatically registered. The in-image device management table T420 includes a column C421 storing the IP address of the network camera 131.

The in-image device management table T420 further includes a column 422 storing an IP address of the image forming apparatus 111, a column C423 storing an X coordinate in the captured image, and a column C424 storing a Y coordinate in the captured image. The IP address of the image forming apparatus 111 cannot be registered with information in the captured image alone. Automatic registration of the IP address in the in-image device management table T420 by the face recognition server 130 is a feature of the present embodiment.

TABLE 4
FEATURE AMOUNT MANAGEMENT TABLE T430

| C431 | C432 |
|---|---|
| User ID | FEATURE AMOUNT DATA |
| USR_00001 | fjieowanoniewafnioewanfoniwafnewaonfoiewan |
| USR_00002 | oenoewnaofniewanofnewanfnoainfeioanwif4e01 |
| USR_00003 | nfoiewnaonfiewnaiofnpewoanfioa90k2msa9o34 |

Table 4 is a feature amount management table T430, in the database 341, used for managing a feature amount of a user of the face recognition server 130.

The feature amount management table T430 includes a column C431 storing a user ID and a column C432 storing binary data as a feature amount representing face information of each user.

TABLE 5
USER MANAGEMENT TABLE T440

| C441 | C442 | C443 |
|---|---|---|
| USER ID | PASSWORD | LATEST LOGIN |
| USR_00001 | ******************** | 2015/4/6, 15:11:05 |
| USR_00002 | ******************** | 2015/4/5, 9:51:12 |
| USR_00003 | ******************** | 2015/4/6, 17:25:43 |

Table 5 is a user management table T440, in the database 351, used by the authentication server 120 to manage users.

The user management table T440 includes a column C441 storing a User ID, a column C442 storing a password used by a user to login, and a column C443 storing the latest login time of the user.

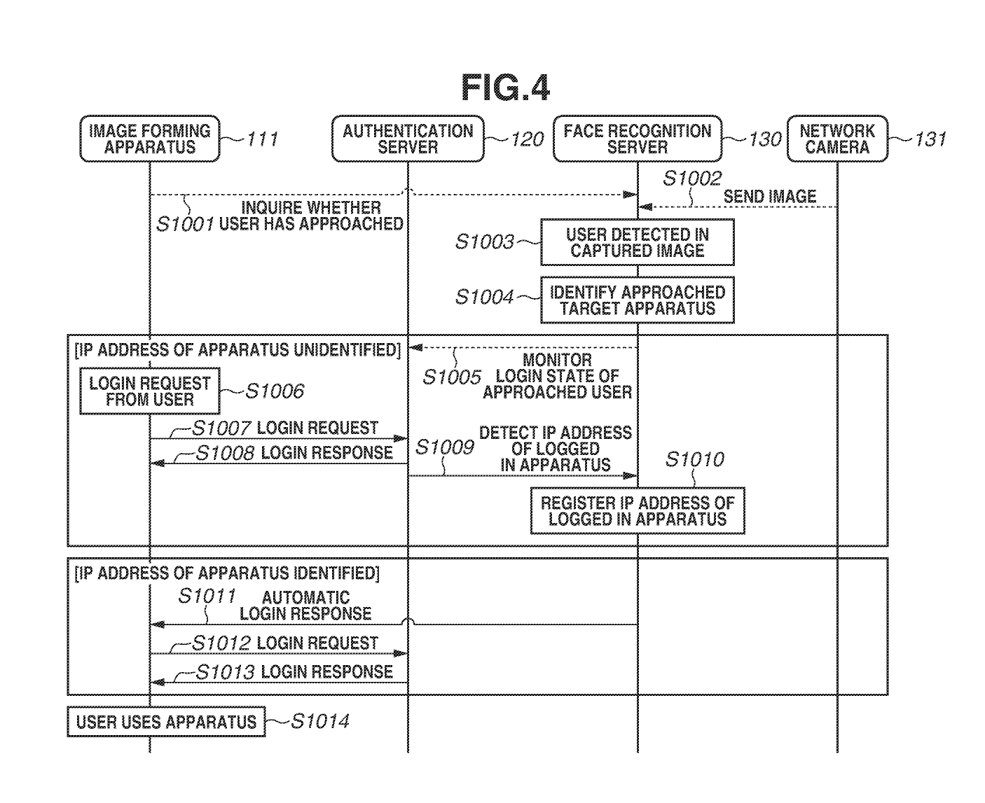

FIG. 4 is a sequence diagram illustrating processing executed in the device information registration system according to the present exemplary embodiment. A registration flow of registering the image forming apparatus 111 to the face recognition server 130 and an automatic login flow into the image forming apparatus 111 are described below with reference to FIG. 4. The processing in each flow is executed through cooperation between the image forming apparatus 111, the authentication server 120, the face recognition server 130, and the network camera 131.

[Processing Executed when Device IP is Unregistered]

In step S1001, the image forming apparatus 111 transmits the inquiry to the face recognition server 130 to check whether a user is approaching. The inquiry includes the IP address of the image forming apparatus 111. The image forming apparatus 111 repeatedly transmits the inquiry at a predetermined interval until an approaching user is detected.

In step S1002, the network camera 131 transmits the captured image of an approaching user to the face recognition server 130. The face recognition server 130 analyzes the received image transmitted from the network camera 131.

In S1003, the face recognition server 130 detects the approaching user in the image. The face recognition server 130 compares the feature amount of a face image in the captured image with the featured values of the users obtained by referring to the feature amount management table T430. The approaching user is identified when the feature amount management table T430 includes a feature amount having a level of similarity greater than or equal to a predetermined threshold to that of the approaching user.

In step S1004, the face recognition server 130 identifies the image forming apparatus 111 approached by the user by referring to the in-image device management table T420. The image forming apparatus 111 to be used by the user can be identified from XY coordinates of the user in the image and the XY coordinates of the image forming apparatus 111 managed in the in-image device management table T420.

Next, a determination is made whether the IP address of the image forming apparatus 111 identified in step S1004 has been registered in the in-image device management table T420. When the IP address is not registered, the processing proceeds to step S1005. When the IP address is registered, the processing proceeds to step S1011.

In step S1005, the face recognition server 130 transmits an inquiry to the authentication server 120 for monitoring a login state of the user who has approached the image forming apparatus 111. The monitoring processing is executed at a predetermined interval until the user logs in, and is terminated when there is no user login for a predetermined threshold period.

In step S1006, the user inputs the user's user ID and password or inputs a login request based on an ID card based authentication through the local UI 315 of the image forming apparatus 111.

In step S1007, the image forming apparatus 111 transmits a login request to the authentication server 120. The login request includes the user ID and the password.

In step S1008, the authentication server 120 refers to the user management table T440, and authenticates the login when the user ID and the password match. Then, as the result of the authentication, the authentication server 120 transmits information indicating whether the user can login to the image forming apparatus 111. In step S1009, the face recognition server 130 detects the IP address of the device logged in by the approached user through the login processing as a result of monitoring the login state in step S1005.

In step S1010, the face recognition server 130 registers the IP address of the logged in image forming apparatus 111 in the in-image device management table T420. Through this processing, the IP address of the image forming apparatus 111 in the image can be automatically registered in column C422 of the in-image device management table T420 by the face recognition server 130. The processing in the flow described above is executed only when the image forming apparatus 111 is used for the first time and thus has an unidentified IP address.

[Processing Executed when Device IP has been Registered]

In step S1011, the face recognition server 130 transmits an automatic login response to the image forming apparatus 111 approached by the user. The inquiry for checking whether the user has approached transmitted in step S1001 includes the IP address of the image forming apparatus 111. Thus, the face recognition server 130 transmits the automatic login response only to the image forming apparatus 111 approached by the user. The automatic login response from the face recognition server 130 includes the user ID of the logging in user.

In step S1012, the image forming apparatus 111 transmits a login request including the user ID to the authentication server 120.

In step S1013, the authentication server 120 transmits a login response to the image forming apparatus 111. The login response indicates that the login is permitted because the login request includes the user ID of the user who was previously identified through the face recognition.

In the present exemplary embodiment, the login request transmitted to the image forming apparatus 111 may not be used, and the user could use the image forming apparatus 111 as soon as the image forming apparatus 111 receives the automatic login response in S1011.

In step S1014, the automatically logged in user uses a desired function of the image forming apparatus 111.

According to the first exemplary embodiment, the identification processing of the IP address of the image forming apparatus 111, required for the automatic login, is implemented through monitoring the login state of the user. In other configurations, the registration processing of the IP address of the image forming apparatus 111 in the image captured by the network camera 131 is extremely cumbersome for an administrator, and is likely to result in faulty registration. With the configuration of the present exemplary embodiment, however, the registration processing of the IP address of the image forming apparatus 111 can be automatically executed, and thus is much less cumbersome to the administrator and is less likely to result in faulty registration.

In the method described in the first exemplary embodiment, the IP address of the image forming apparatus 111 managed in the in-image device management table T420 of the face recognition server 130 is identified. More specifically, the method includes checking the login state of the user who has approached the image forming apparatus 111 by transmitting an inquiry to the authentication server 120, and registering the IP address of the logged in image forming apparatus 111 in the in-image device management table T420.

In a second exemplary embodiment, a method is described where the IP address of the image forming apparatus 111 is registered in the in-image device management table T420 through monitoring a print job held in a print server 140.

In the second exemplary embodiment, only the portions different from the first exemplary embodiment will be described.

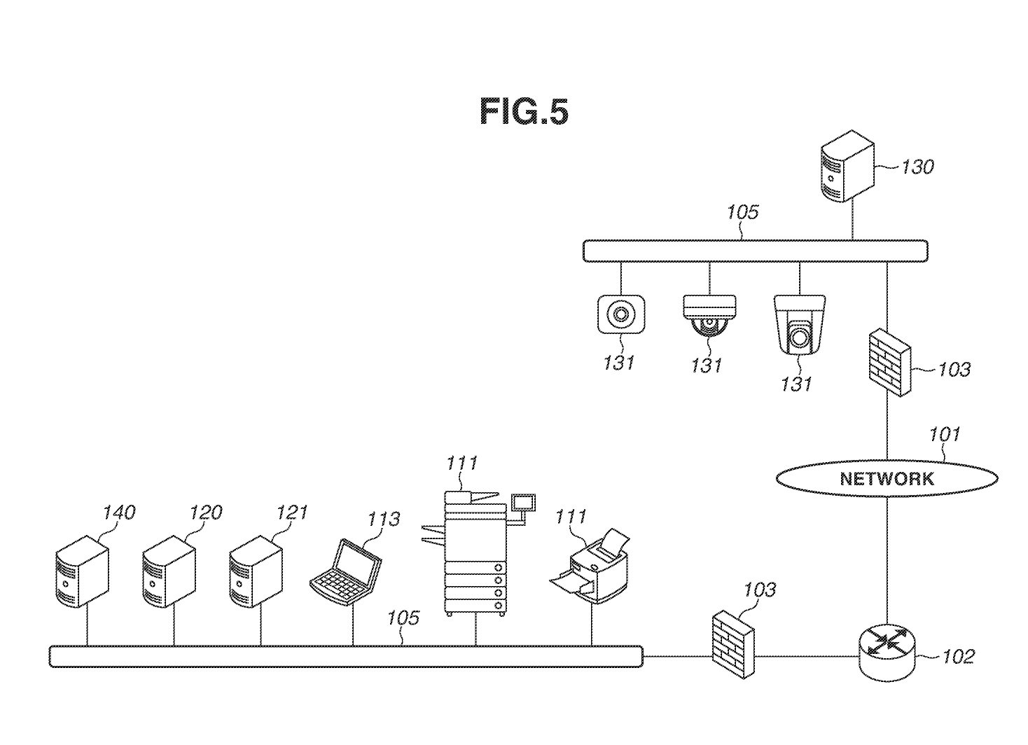

FIG. 5 is a diagram illustrating a configuration of a device information registration system according to the present exemplary embodiment. The configuration illustrated in FIG. 5 is obtained by adding the print server 140 to the configuration illustrated in FIG. 1. Portions of the configuration other than the print server 140 are the same as those in the first exemplary embodiment, and therefore will not be described.

In FIG. 5, the print server 140 is installed in a general office environment. The print server 140 according to the present exemplary embodiment can be accessed by a plurality of the image forming apparatuses 111. Thus, a print job input to the print server 140 in advance by a user can be printed by any of the plurality of image forming apparatuses 111.

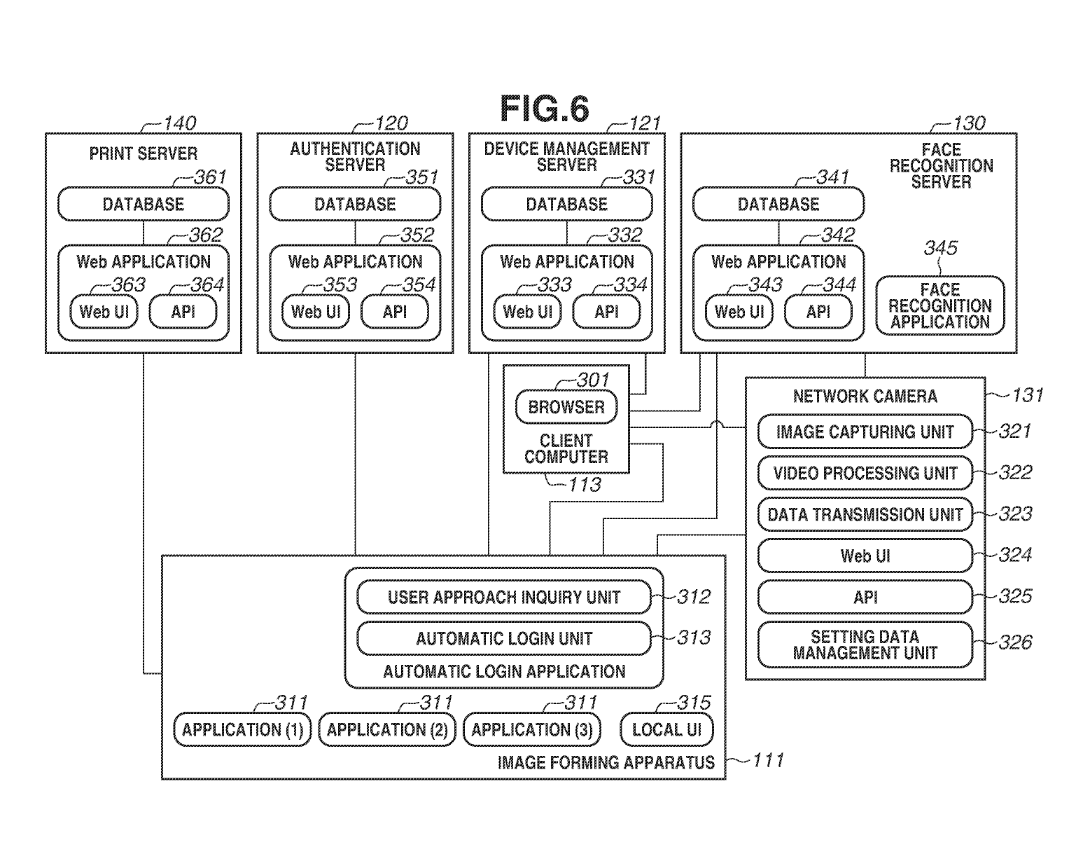

FIG. 6 is a diagram illustrating a software configuration of the device information registration system according to the present exemplary embodiment. Portions that are the same as those in FIG. 3 are denoted with the same reference numerals and will not be described.

In FIG. 6, the print server 140 includes a database 361 and a Web application 362. The database 361 stores data required for various functions of the print server 140. The Web application 362 provides a Web UI 363 and an API 364. The Web application 362 processes a request received from other apparatuses through a network. Thus, the Web application 362 accesses data in the database 361 to execute various functions, and returns a response as appropriate.

TABLE 6
JOB MANAGEMENT TABLE T450

| C451 | C452 | C453 | C454 |
|---|---|---|---|
| JOB ID | USER ID | STATUS | DEVICE IP ADDRESS |
| JOB_00001 | USR_00001 | COMPLETED | 192.168.1.101 |
| JOB_00001 | USR_00001 | PRINTING | 192.168.1.101 |
| JOB_00001 | USR_00001 | TO BE PRINTED | null |
| JOB_00002 | USR_00002 | TO BE PRINTED | null |
| JOB_00003 | USR_00003 | TO BE PRINTED | null |

Table 6 is a job management table T450 in the database 361 for managing a print job held by the print server 140 illustrated in FIG. 5.

The job management table T450 includes a column C451 storing a job ID for uniquely identifying a job, a column C452 storing a user ID for uniquely identifying a user who has input the job, a column C453 storing a status of the print job, and a column C454 storing an IP address of the image forming apparatus 111 that has executed the print job.

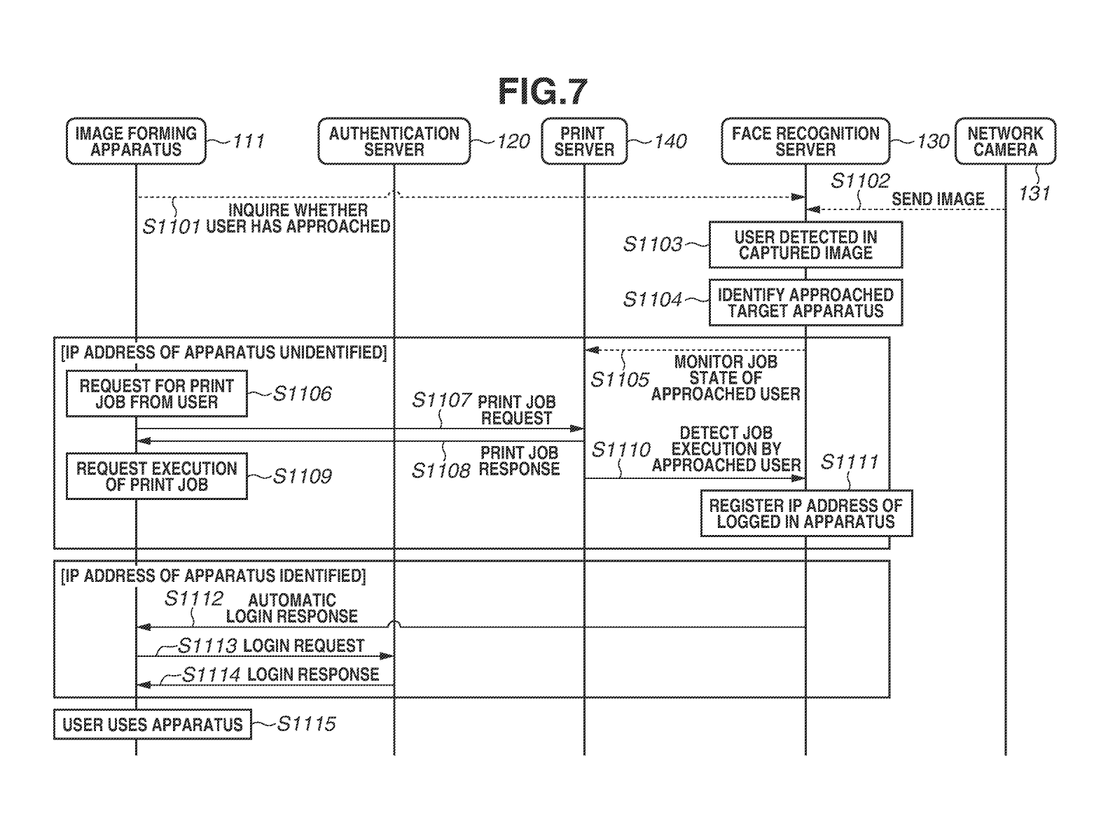

FIG. 7 is a diagram illustrating processing executed in the device information registration system according to the present exemplary embodiment. A registration flow of the IP address of the image forming apparatus 111 in the face recognition server 130 is described below with reference to FIG. 7. The processing of the registration flow is executed through cooperation between the image forming apparatus 111, the authentication server 120, the face recognition server 130, the network camera 131, and the print server 140.

[Processing Executed when Device IP is Unregistered]

Processing in steps S1101 to S1104 and processing in steps S1112 to S1115 are respectively similar to the processing in steps S1001 to S1004 and the processing in steps S1011 to S1014 in the first exemplary embodiment, and therefore will not be described.

In step S1105, the face recognition server 130 transmits an inquiry to the print server 140 for monitoring a status of a print job that has been input by a user who has approached the image forming apparatus 111. The monitoring processing is executed at a predetermined interval until the job input by the user is executed and is terminated when the job is not executed by the user for a predetermined threshold period.

In step S1106, the user requests a print job held by the print server 140 through the local UI 315 of the image forming apparatus 111.

In step S1107, the image forming apparatus 111 transmits a print job request to the print server 140. This print job request includes a print job ID, a user ID, and a device ID. In step S1108, the print server 140 transmits a print job response, including print data, to the image forming apparatus 111. In step S1109, the image forming apparatus 111 executes the print job received in step S1108.

In step S1110, the face recognition server 130 detects, as a result of monitoring the execution status of the print job by the approached user in step S1005, the execution of the print job that has been input by the user who has approached the image forming apparatus 111. When the print job is completed with the user ID of the approached user matching one of the user IDs managed in the job management table T450 in the job management table T450, the IP address of the device that has executed the print job in the job management table T450 can be detected as the IP address of the device approached by the user.

In step S1111, the face recognition server 130 registers the IP address of the device detected in step S1110 into the in-image device management table T420. The processing in the flow described above is executed only when the image forming apparatus 111 is used for the first time and thus has an unidentified IP address.

In the method described in the second exemplary embodiment, the IP address of the image forming apparatus 111 is registered into the in-image device management table T420 through monitoring a job held by the print server 140.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-187998, filed Sep. 25, 2015, which is hereby incorporated by reference herein in its entirety.

What is claimed is:

1. A device information registration system comprising:
a network camera;
a first management apparatus configured to execute authentication processing for a user logging into a device; and
a second management apparatus configured to manage a device or a user in an image captured by the network camera,
wherein the first management apparatus includes an authentication unit configured to execute the authentication processing for the user logging into the device, and
wherein the second management apparatus includes:
a first detection unit configured to detect a user approaching the device based on the image captured by the network camera;
a second detection unit configured to monitor, in a case where the user is detected, the authentication processing to detect whether the user has logged into the device;
a third detection unit configured to detect an IP address of the device logged into by the user; and
a registration unit configured to associate and register the detected IP address and position information of the device in the image captured by the network camera into a device information table.

2. The device information registration system according to claim 1, further comprising a determination unit configured to determine whether an IP address of a device approached by a user is registered in the device information table,
wherein, in a case where the determination unit determines that the IP address of the device approached by the user is not registered in the device information table, the registration unit associates and registers the IP address of the approached device and position information of the approached device in the image captured by the network camera into the device information table.

3. The device information registration system according to claim 1, wherein a plurality of network cameras is used to capture images of different angles of view of a single device.

4. A device information registration system comprising:
a network camera;
a first management apparatus configured to store and manage a print job; and
a second management apparatus configured to manage a device or a user in an image captured by the network camera,
wherein the first management apparatus includes:
a response unit configured to receive a print job request from the device and transmit a response including a corresponding print job to the device; and
a first detection unit configured to detect an IP address of the device to which the print job is transmitted,
wherein the second management apparatus includes:
a second detection unit configured to detect a user approaching the device based on the image captured by the network camera;
a third detection unit configured to monitor, in a case where the user is detected, an execution status of the print job requested by the user through the device, and detect an IP address of a device that has executed the print job by transmitting an inquiry to the first management apparatus; and
a registration unit configured to associate and register in a device information table the IP address of the detected device and position information of the device in the image captured by the network camera.

5. A control method for a device information registration system including a network camera, a first management apparatus, and a second management apparatus, the control method comprising:
executing authentication processing for a user logging into a device;
detecting a user approaching the device based on an image captured by the network camera;
monitoring, in case where the user is detected, the authentication processing to detect whether the user has logged into the device;
detecting an IP address of the device logged into by the user; and
associating and registering the detected IP address and position information of the device in the image captured by the network camera into a device information table.

6. The control method according to claim 1, further comprising determining whether an IP address of a device approached by a user is registered in the device information table, and
wherein, in a case where it is determined that the IP address of the device approached by the user is not registered in the device information table, the associating and registering the IP address of the approached device and position information of the approached device in the image captured by the network camera into the device information table.

7. The control method according to claim 1 further comprising capturing images of different angles of view of a single device using a plurality of network cameras.

8. A control method for a device information registration system including a network camera, a first management apparatus, and a second management apparatus, the control method comprising:
receiving a print job request from a device;
transmitting a response including a corresponding print job to the device;
detecting an IP address of the device to which the print job is transmitted;
detecting a user approaching the device based on an image captured by the network camera,
monitoring, in a case where the user is detected, an execution status of the print job requested by the user through the device;
detecting an IP address of the device that has executed the print job by transmitting an inquiry; and
associating and registering the detected IP address and position information of the device in the image captured by the network camera in a device management table.

9. A computer readable storage medium storing computer executable instructions for causing a computer to execute a control method for a device information registration system including a network camera, a first management apparatus, and a second management apparatus, the control method comprising:
executing authentication processing for a user logging into a device;
detecting a user approaching the device based on an image captured by the network camera;
monitoring, in case where the user is detected, the authentication processing to detect whether the user has logged into the device;
detecting an IP address of the device logged into by the user; and
associating and registering the detected IP address and position information of the device in the image captured by the network camera into a device information table.

10. A computer readable storage medium storing computer executable instructions for causing a computer to execute a control method for a device information registration system including a network camera, a first management apparatus, and a second management apparatus, the control method comprising:
receiving a print job request from a device;
transmitting a response including a corresponding print job to the device;
detecting an IP address of the device to which the print job is transmitted;
detecting a user approaching the device based on an image captured by the network camera,
monitoring, in a case where the user is detected, an execution status of the print job requested by the user through the device;
detecting an IP address of the device that has executed the print job by transmitting an inquiry; and
associating and registering the detected IP address and position information of the device in the image captured by the network camera in a device management table.
